(19) United States
(12) Patent Application Publication
(10) Pub. No.: US 2025/0196650 A1
(43) Pub. Date: Jun. 19, 2025

(54) TORQUE MANAGEMENT SYSTEM FOR ELECTRIC VEHICLE

(71) Applicant: DENSO International America, Inc., Southfield, MI (US)

(72) Inventors: Swanand LIMAYE, Farmington Hills, MI (US); Guriqbal SINGH, Belle River (CA); Kenji MORIKAWA, Kariya-City (JP); Sergio PUJOLS, Canton, MI (US); Robert BRINKER, Ortonville, MI (US)

(73) Assignee: DENSO International America, Inc., Southfield, MI (US)

(21) Appl. No.: 18/979,998

(22) Filed: Dec. 13, 2024

Related U.S. Application Data
(60) Provisional application No. 63/610,154, filed on Dec. 14, 2023.

(51) Int. Cl. B60L 7/24; B60L 15/20

(52) U.S. Cl. CPC B60L 7/24; B60L 15/2036; B60L 2240/12; B60L 2240/14; B60L 2240/22; B60L 2240/24; B60L 2240/423; B60L 2240/465; B60L 2240/642

(57) ABSTRACT

An electric vehicle control system, including a vehicle controller, power controller, braking controller, and a steering controller. The vehicle controller, which is operably coupled to the power and braking controllers, is configured to collect and process various vehicle conditions to determine optimal torque distribution and braking application. The power controller, which is linked to electric motors, is configured to execute torque distribution instructions from the vehicle controller. The braking controller, which is connected to the vehicle's braking system, is configured to execute instructions to apply brakes as needed. The braking application instructions instruct the braking system to apply a braking force to one or more wheels in response to the vehicle conditions and the torque distribution instructions instruct the one or more motors to increase or decrease torque in response to the vehicle conditions.

### CROSS-REFERENCE TO RELATED APPLICATION

This application claims the benefit of U.S. Provisional Application No. 63/610,154 filed on Dec. 14, 2023, the entire disclosure of which is incorporated herein by reference.

### FIELD

The present disclosure relates to torque management systems for electric vehicles.

### BACKGROUND

This section provides background information related to the present disclosure, which is not necessarily prior art.

Electric vehicles have predominantly utilized a centralized powertrain architecture. This conventional design typically involves a single electric motor or a pair of motors that drive the vehicle, connected to the wheels through a transmission system. Conventional electric powertrains feature a standard, centralized arrangement of components, including the motor, transmission, and often the battery pack. However, the centralized powertrain architecture imposes several limitations, which the present disclosure overcomes.

### SUMMARY

This section provides a general summary of the disclosure, and is not a comprehensive disclosure of its full scope or all of its features.

The present disclosure provides for, in various features, an electric vehicle control system. The system includes a vehicle controller configured to collect and process one or more vehicle conditions from one or more sensors, determine torque distribution and braking application based on the vehicle conditions, and generate torque distribution instructions and braking application instructions, a power controller configured to control torque generation of one or more electric motors based on the torque distribution instructions received from the vehicle controller, a braking controller configured to control a braking system of the vehicle based on the braking application instructions received from the vehicle controller, and wherein the braking application instructions instruct the braking system to apply a braking force to one or more wheels in response to the vehicle conditions and wherein the torque distribution instructions instruct the one or more motors to increase or decrease torque in response to the vehicle conditions.

In further features, the electric vehicle control system includes that the one or more vehicle conditions include one or more of vehicle speed, vehicle acceleration, vehicle yaw rate, vehicle steering angle, and wheel slip, and each vehicle condition is received from one or more sensors or determined from signals received from one or more sensors.

In further features, the electric vehicle control system includes that the vehicle controller determines a vehicle dynamic state based on the one or more vehicle conditions.

In further features, the electric vehicle control system includes that the vehicle dynamic state may be one or more of oversteering, understeering, traveling uphill, traveling downhill, and a loss of traction in one or more wheels.

In further features, the electric vehicle control system includes that the vehicle controller, based on the vehicle dynamic state, determines that torque vectoring, braking application, or both should be implemented.

In further features, the electric vehicle control system includes that the torque distribution instructions received by the power controller include instructions to increase torque or decrease torque for each of the one or more electric motors.

In further features, the electric vehicle control system includes that there is provided a battery controller operably coupled to the vehicle controller and a battery, wherein the vehicle controller determines a charge reception capability of the battery based on a predictive algorithm, and wherein the vehicle controller determines the braking application based on the charge reception capability of the battery.

In further features, the electric vehicle control system includes that the electric vehicle control system includes that the vehicle controller, the power controller, and the braking controller are each included in a module configured to be attached to a platform for an electric vehicle.

In further features, the electric vehicle control system includes that the vehicle controller, the power controller, and the braking controller are communicatively coupled wirelessly.

The present disclosure further provides for a method for controlling torque vectoring and braking application of an electric vehicle. The method includes: collecting, by a vehicle controller, one or more vehicle conditions associated with a dynamic state of the vehicle, determining, by the vehicle controller, the dynamic state of the vehicle based on the one or more vehicle conditions, determining, by the vehicle controller, that one or more of torque vectoring, braking application, or both are needed based on the determined dynamic state of the vehicle, determining, by the vehicle controller, an optimal torque vectoring and an optimal braking application based on the determined dynamic state of the vehicle, and sending, by the vehicle controller, one or more of torque distribution instructions based on the determined optimal torque vectoring to a power controller, braking application instructions based on the determined optimal braking application to a braking controller, or both, wherein the power controller is configured to control torque generation of one or more electric motors based on the torque distribution instructions received from the vehicle controller and wherein the braking controller is configured to control a braking system of the vehicle based on the braking application instructions received from the vehicle controller.

In further features, the method includes that the vehicle conditions include one or more of vehicle speed, vehicle acceleration, vehicle yaw rate, vehicle steering angle, and wheel slip.

In further features, the method includes that the vehicle dynamic state may be one or more of oversteering, understeering, traveling uphill, traveling downhill, and a loss of traction in one or more wheels.

In further features, the method includes that the torque distribution instructions include instructions to increase torque or decrease torque for each of one or more electric motors.

The present disclosure provides for, in various features, an electric vehicle control system. The system a vehicle controller configured to collect and process one or more vehicle conditions from one or more sensors, determine torque distribution and braking application based on the vehicle conditions, and generate torque distribution instructions and braking application instructions, a power controller configured to control torque generation of one or more electric motors based on the torque distribution instructions received from the vehicle controller, and a braking controller configured to control a braking system of the vehicle based on the braking application instructions received from the vehicle controller, wherein the braking application instructions instruct the braking system to apply a braking force to one or more wheels in response to the vehicle conditions, wherein the torque distribution instructions instruct the one or more motors to increase or decrease torque in response to the vehicle conditions, and wherein the vehicle controller, the power controller, and the braking controller are each included in a module configured to be attached to a platform for an electric vehicle.

In further features, the electric vehicle control system includes that the one or more vehicle conditions include one or more of vehicle speed, vehicle acceleration, vehicle yaw rate, vehicle steering angle, and wheel slip, and each vehicle condition is received from one or more sensors or determined from signals received from one or more sensors.

In further features, the electric vehicle control system includes that the vehicle controller determines a vehicle dynamic state based on the one or more vehicle conditions.

In further features, the electric vehicle control system includes that the vehicle dynamic state may be one or more of oversteering, understeering, traveling uphill, traveling downhill, and a loss of traction in one or more wheels.

In further features, the electric vehicle control system includes that the vehicle controller, based on the vehicle dynamic state, determines that torque vectoring, braking application, or both should be implemented.

In further features, the electric vehicle control system includes that the torque distribution instructions received by the power controller include instructions to increase torque or decrease torque for each of the one or more electric motors.

In further features, the electric vehicle control system includes that there is provided a battery controller operably coupled to the vehicle controller and a battery, wherein the vehicle controller determines a charge reception capability of the battery based on a predictive algorithm, and wherein the vehicle controller determines the braking application based on the charge reception capability of the battery.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary vehicle platform including four electric vehicle propulsion, steering, and suspension systems according to the present disclosure;

FIG. 2 illustrates one of the electric vehicle propulsion, steering, and suspension systems of FIG. 1;

FIG. 3 is a schematic view of an exemplary brake-by-wire system in accordance with the present disclosure installed in an exemplary vehicle;

FIG. 4 is a block diagram of an exemplary brake-by-wire system of the present disclosure;

FIG. 5 is a block diagram of an exemplary electric vehicle control system of the present disclosure; and

FIG. 6 is a flow chart of an exemplary method of the present disclosure for controlling torque vectoring and braking application of an electric vehicle according to a principle of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure advantageously decentralizes electric vehicle powertrain into four independent modules, each integrated into a wheel of the vehicle. This configuration provides a more flexible vehicle design because it eliminates the need for a central powertrain and transmission shaft, leading to a more efficient use of space and potentially reducing the vehicle's overall weight.

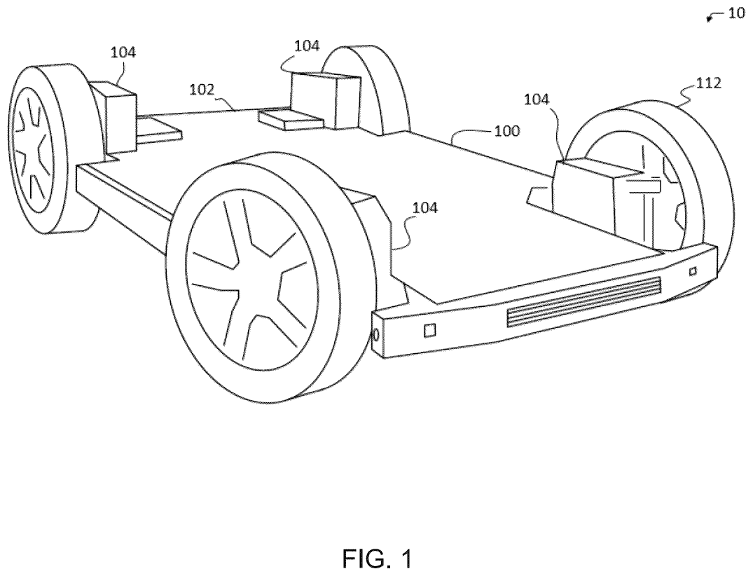

FIG. 1 illustrates an exemplary platform assembly 100 for an electric vehicle 10. In the example illustrated, the platform assembly 100 is configured as a skateboard chassis. The platform assembly 100 may alternatively be configured as any other suitable vehicle platform. The electric vehicle 100 may be configured as any suitable type of electric vehicle, such as, but not limited to, a plug-in hybrid electric vehicle (PHEV), a battery electric vehicle (BEV), a range-extended electric vehicle (REEV), etc.

In the example illustrated, the platform assembly 100 is configured as a pickup truck platform. Alternatively, the platform assembly 100 may be configured for any other suitable type of vehicle including, but not limited to, light trucks, sporty utility vehicles (SUVs), crossover utility vehicles (CUVs), vans, and off-road vehicles. The platform assembly 100 includes a main body 102 and at least one electric vehicle propulsion, steering, and suspension system 104. In one example, the electric vehicle propulsion, steering, and suspension system may be packaged as a module. The module may be a self-contained assembly including all of the features of the electric vehicle propulsion, steering, and suspension system 104. The module may be configured to attach to the main body of a platform assembly. The module may further include a braking element and an anti-locking braking system (ABS). Examples of a braking element include, but are not limited, to disc brakes, drum brakes, and electromagnetic brakes.

The module may include a “plug and play” design to allow the module to more easily connect to the chassis or main body 102. Once attached to the chassis or main body 102, the module may be secured with a plurality of bolts or a single bolt. A plurality of bolts may include two bolts, three bolts, four bolts, five bolts, or more.

The module may further include a plurality of connection points, including coolant lines, HV cables, and communication cables. These connections may connect to, or interface with, matching connection points on the chassis or main body 102. The module may be configured to be attached to a vehicle platform on a production line.

The main body 102 forms the foundational structure. The main body 102 may contain a battery (not shown). As depicted, the main body 102 is physically connected to four electric vehicle propulsion, steering, and suspension systems 104, but a greater or lesser number of electric vehicle propulsion, steering, and suspension systems 104 may be contemplated. The electric vehicle propulsion, steering, and suspension system is discussed in more detail below.

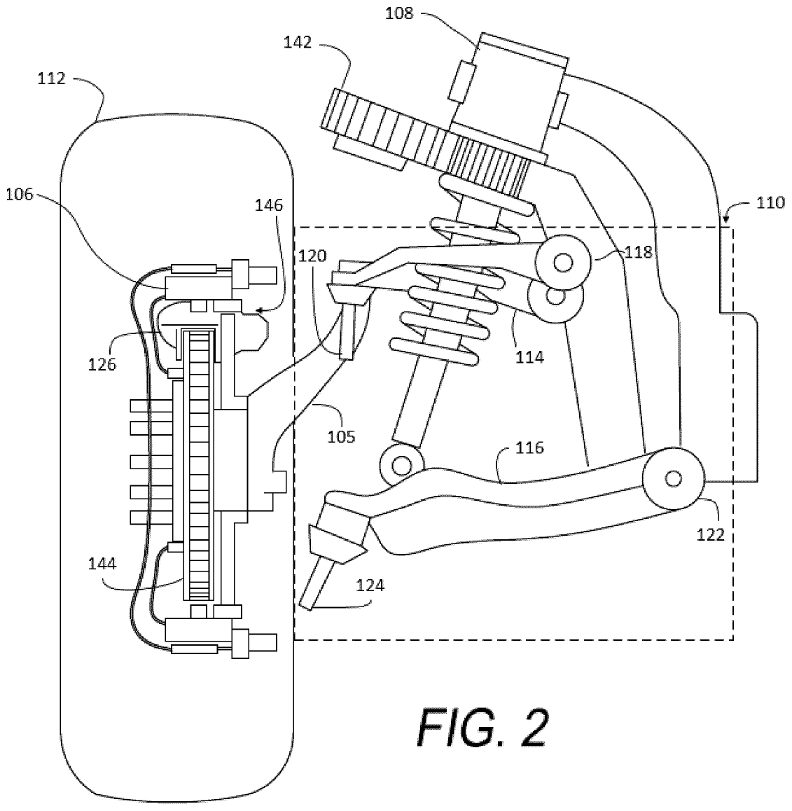

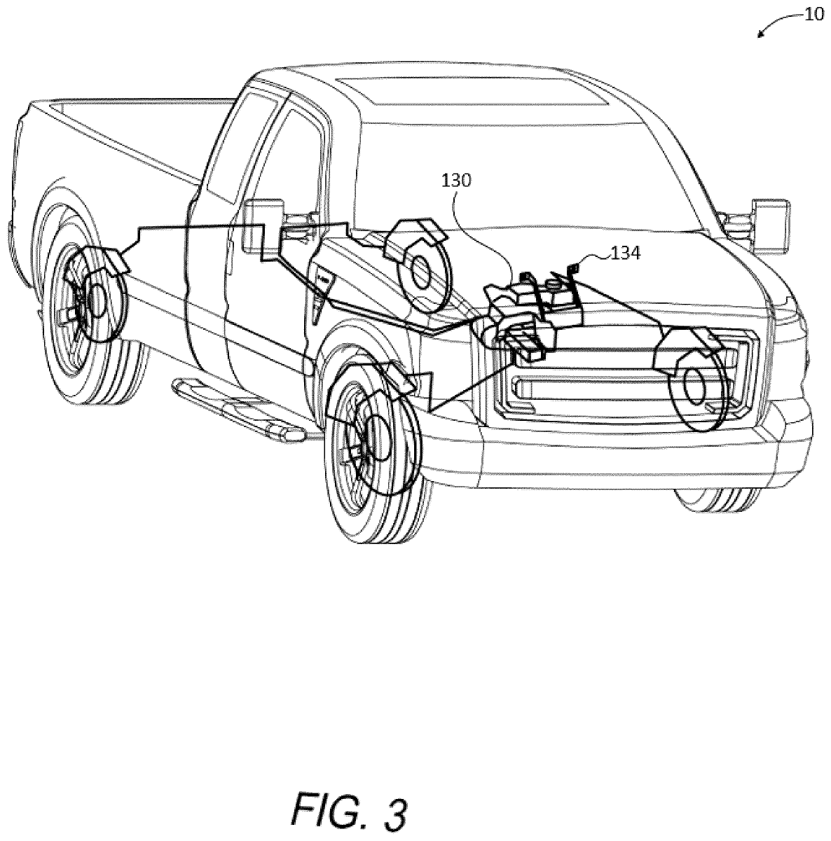

FIG. 2 illustrates an example of the electric vehicle propulsion, steering, and suspension system 104. Each electric vehicle propulsion, steering, and suspension system 104 includes an in-wheel motor 106, an integrated inverter 107, a direct steering motor 108, a brake-by-wire system 130 (FIGS. 3A and 3B, for example), and a double wishbone suspension 110.

The in-wheel motor 106 may be located within or proximate to a tire assembly 112. The in-wheel motor 106 may be an electric drive motor (EDM). The in-wheel motor 106 may form a ring within the tire assembly 112. The in-wheel motor 106 is configured to drive the tire of the tire assembly 112.

The direct steering motor 108 may be attached to the top of the electric vehicle propulsion, steering, and suspension system 104. The direct steering motor 108 may include an electric motor coupled to a gear assembly 142. The gear assembly 142 may be further coupled to the double-wishbone suspension such that, when the gear assembly is rotated by the direct steering motor, the electric vehicle propulsion, steering, and suspension system is rotated.

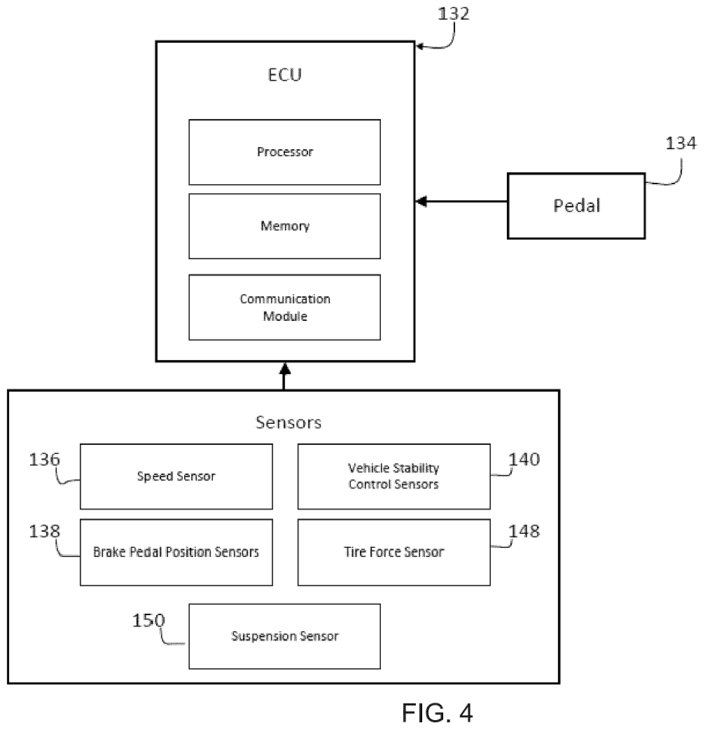

The brake-by-wire system 130 (see FIGS. 3A and 3B, for example), may include an electronic control unit (ECU) 132 (FIG. 4), a number of brake actuators 126, a pedal feel simulator 134, and a number of sensors 136, 138, 140 (FIG. 4). The ECU 132 may receive input from a number of sensors, including, but not limited to, wheel speed sensors 136, brake pedal position sensors 138, and vehicle stability control sensors 140. The ECU 132 processes this data to determine the appropriate braking force for each wheel, ensuring optimal braking performance under varying conditions. Each tire assembly 112 is equipped with a brake actuator 126, which directly applies the braking force to the wheel. The brake actuator 126 may include or be a component of a hydraulic, electronic, or magnetic braking system. These actuators 126 are controlled by the ECU 132 and are capable of precise and rapid modulation of braking force.

As illustrated in FIG. 2, for example, the double wishbone suspension 110 includes an upper wishbone arm 114 and a lower wishbone arm 116, each having at least one proximal end point 118, 120 and at least one distal end point 122, 124 (proximal indicating the end point nearest the center of the vehicle 10 and distal indicating the end point furthest from the center of the vehicle 10). The proximal end points of both arms 114, 116 are pivotally connected to the chassis of the vehicle, allowing for vertical movement. The distal end points of the arms 114, 116 are connected to a knuckle assembly 105, which, in turn, is attached to the tire assembly 112.

The double-wishbone suspension typical of light trucks presents design challenges for an electric vehicle propulsion, steering, and suspension system 104. The electric vehicle propulsion, steering, and suspension system 104 requires a large number of components to occupy a limited amount of space in the tire assembly 112. The double-wishbone suspension 110 is particularly configured to accommodate the space needs of these components.

The lower wishbone arm 116 is shortened relative to a typical double-wishbone suspension to accommodate the space needs of the components and reduce the unsprung mass of the vehicle 10. The length of the lower wishbone arm 116 may be reduced proportionally to the reduction of the distance between the upper wishbone arm 114 and the lower wishbone arm 116. In another example, a subframe design may be used allowing the electric vehicle propulsion, steering, and suspension system to move with the wheel.

The upper wishbone arm 114 has also been lowered relative to the tire assembly to reduce the overall height of the electric vehicle propulsion, steering, and suspension system and increase the size of the frunk space. Lowering the upper wishbone arm reduces the distance between the upper wishbone arm 114 and the lower wishbone arm 116 and alters the roll center of the vehicle. The roll center is a virtual point in a vehicle around which the chassis rolls, significantly influencing handling during cornering. Torque vectoring techniques may be applied to address the changes in the vehicle roll center.

For example, applying torque directly through the in-wheel motors 106 to each wheel and selectively steering each wheel according to real-time feedback provided by vehicle sensors may improve stability. In another example, torque vectoring may include algorithmic control and monitoring of a number of vehicle sensors including a tire force sensor 148 which measures the force being applied to a tire by the pavement. Algorithmic control and monitoring of sensors may further include, but is not limited to, other common vehicle sensors, such as the speed of the vehicle 10 and sensors monitoring the motion of the suspension 150.

The unsprung mass is that part of the vehicle that is not supported by springs (e.g. tires, nuts, linkages). This is an especially important concern in an electric vehicle propulsion, steering, and suspension system as the electric vehicle propulsion, steering, and suspension system 104 moves components, such as the electric drive motor, into the wheel, increasing the unsprung mass. An increased unsprung mass results in a slower wheel reaction time to events like potholes, meaning it takes longer for the wheel to rise back from the pothole due its mass. This extra mass has an overall impact on handling and stability. In another example, the above torque vectoring techniques may be applied to overcome the handling issues introduced by the increased unsprung mass.

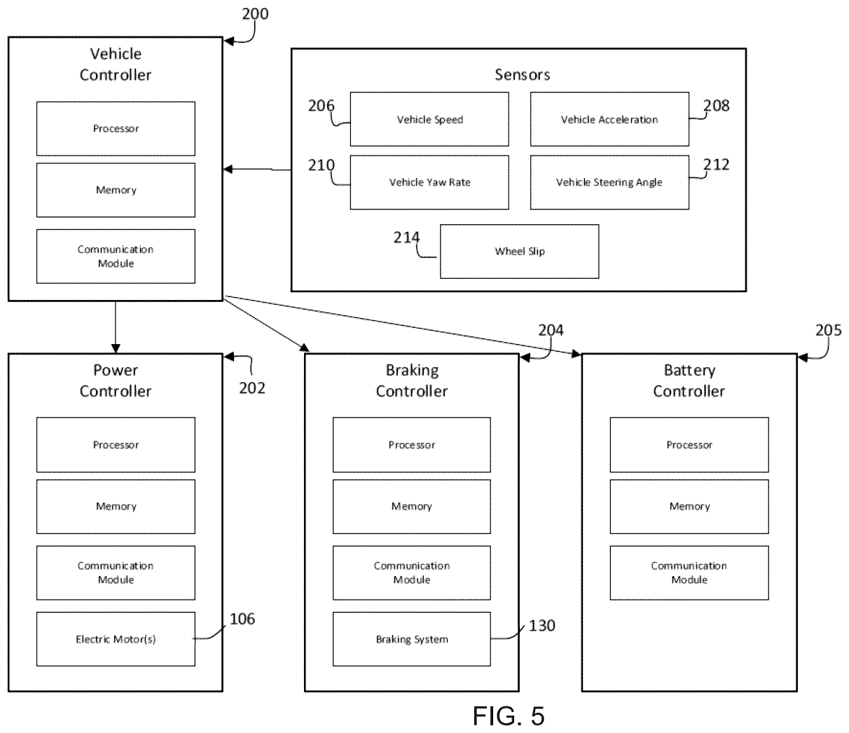

FIG. 5 illustrates an example block diagram of an electric vehicle control system for applying torque vectoring and differential braking techniques. The system includes a vehicle controller 200, a power controller 202, and a braking controller 204, each operably coupled and configured to facilitate dynamic vehicle control and increase the energy/battery usage efficiency of the vehicle. Though each controller is operably coupled, it should be understood that this coupling may be direct or indirect, wired or wireless. In one example, the operable coupling between controllers is facilitated through intermediary components. In another example, the coupling between controllers is facilitated through both wired and wireless communications.

The vehicle controller 200, which may be a Vehicle Control Unit (VCU) or Electronic Control Unit (ECU), is operably and communicatively coupled to the power controller 202 and the braking controller 204. The vehicle controller 200 collects vehicle conditions from an array of sensors, such as sensors collecting information regarding the vehicle speed 206, vehicle acceleration 208, vehicle yaw rate 210, vehicle steering angle 212, and vehicle wheel slip 214. The collection of vehicle conditions may be performed passively by receiving a stream of signals from the sensors. Once the vehicle conditions are received, the vehicle controller 200 determines the vehicle's dynamic state based on the vehicle conditions. For example, the vehicle controller 200 may determine that the vehicle's dynamic state is oversteering or understeering. In another example, the vehicle controller may determine that the vehicle has lost traction on one or more wheels.

The vehicle controller 200 may also be operably and communicatively coupled to a battery controller 205. The battery controller 205 may determine and relay the current charge reception capability of the battery to the vehicle controller 200. If the battery controller 205 reports that the battery is currently capable of receiving a charge, the vehicle controller 200 may include regenerative braking as an option in its determination of the braking application instructions to be sent to braking controller 204. For example, if the vehicle controller 200 determines that the dynamic state of the vehicle requires a braking response and the current charge reception capability of the battery is acceptable, the vehicle controller 200 may activate regenerative braking and, in turn, relay instructions to the braking controller to brake more lightly than it otherwise would have.

Power controller 202 may be operably and communicatively coupled to one or more in-wheel electric motors 106. The power controller 202 may be tasked with receiving and executing torque distribution instructions that vary torque across the motors from the vehicle controller 200. This includes instructions to either increase or decrease torque as necessary for each motor and as dictated by the vehicle controller 200. For example, the power controller 202 may receive and execute torque distribution instructions from the vehicle controller 200 to increase torque on the front, driver-side motor only. Alternatively, the power controller 202 may receive and execute torque distribution instructions from the vehicle controller 200 to increase torque on the front, driver-side motor and the back, driver-side motor and to decrease torque on the front, passenger-side motor and the back, passenger-side motor.

Braking controller 204 is operably and communicatively coupled to the vehicle's braking system 130. The braking controller 204 executes braking application instructions received from the vehicle controller 200. For example, the braking controller 204 may receive and execute braking application instructions from the vehicle controller 200 to apply a braking force on the front, driver-side tire only. Alternatively, the braking controller 204 may receive and execute braking application instructions from the vehicle controller 200 to apply a first braking force on the front, driver-side tire and the back, driver-side tire and to apply a second, weaker braking force on the front, passenger-side tire and the back, passenger-side tire.

The braking application instructions may be based on the vehicle's dynamic state. In another example, the braking application instructions may be based on the current charge reception capability of the battery, potentially involving a battery controller.

The vehicle controller 200 collects vehicle conditions to determine the vehicle's dynamic state and assesses whether torque vectoring, braking application, or a combination thereof is required. Based on this assessment, the vehicle controller 200 determines and sends the optimal torque vectoring and braking application instructions to the power controller 202 and the braking controller 204, respectively. The optimal instructions are those deemed most energy-efficient, ensuring the system's overall efficacy and sustainability.

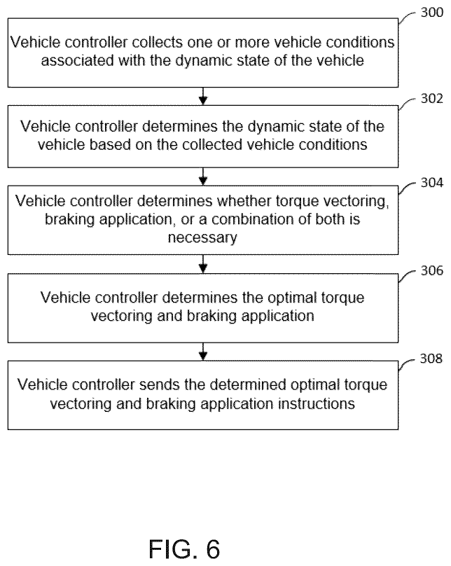

FIG. 6 illustrates a flow chart depicting the operational steps of a method for controlling torque vectoring and braking application in an electric vehicle by the vehicle controller 200, or any other suitable vehicle controller.

At step 300, the vehicle controller 200 collects one or more vehicle conditions associated with the dynamic state of the vehicle. These conditions may include vehicle speed 206, vehicle acceleration 208, vehicle yaw rate 210, vehicle steering angle 212, and vehicle wheel slip 214.

At step 302, the vehicle controller 200 determines the dynamic state of the vehicle based on the collected vehicle conditions in step 300. For example, the vehicle controller 200 may determine, based on collected vehicle condition data including wheel slippage on one or more tires, the vehicle acceleration 208, and the vehicle yaw rate 210, that the vehicle is making a turn, accelerating too quickly, and has lost traction between one or more ties and the road.

At step 304, the vehicle controller 200 determines whether torque vectoring, braking application, or a combination of both is necessary based on the determination in step 302.

At step 306, the vehicle controller 200 determines the optimal torque vectoring and braking application. The vehicle controller 200 calculates the most effective and energy-efficient distribution of torque and braking forces required to maintain or achieve desired vehicle behavior. Continuing the above example, in response to a loss of traction on one or more tires during a turn, the vehicle controller 200 may apply torque vectoring to restore traction to the affected tires. In this case, the vehicle controller may determine that reducing torque on the one or more wheels that have lost traction and increasing torque on the remaining wheels is the optimal means of restoring traction.

At step 308, the vehicle controller 200 sends, via signal, the determined optimal torque vectoring and braking application instructions of step 306 to the power controller, the braking controller, or both.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

A module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

A module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of a module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. An electric vehicle control system comprising:
a vehicle controller configured to collect and process one or more vehicle conditions from one or more sensors, determine torque distribution and braking application based on the vehicle conditions, and generate torque distribution instructions and braking application instructions;
a power controller configured to control torque generation of one or more electric motors based on the torque distribution instructions received from the vehicle controller; and
a braking controller configured to control a braking system of the vehicle based on the braking application instructions received from the vehicle controller;
wherein the braking application instructions instruct the braking system to apply a braking force to one or more wheels in response to the vehicle conditions and wherein the torque distribution instructions instruct the one or more motors to increase or decrease torque in response to the vehicle conditions.

2. The electric vehicle control system of claim 1, wherein the one or more vehicle conditions include one or more of vehicle speed, vehicle acceleration, vehicle yaw rate, vehicle steering angle, and wheel slip; and
wherein each vehicle condition is received from one or more sensors or determined from signals received from one or more sensors.

3. The electric vehicle control system of claim 2, wherein the vehicle controller determines a vehicle dynamic state based on the one or more vehicle conditions.

4. The electric vehicle control system of claim 3, wherein the vehicle dynamic state may be one or more of oversteering, understeering, traveling uphill, travelling downhill, and a loss of traction in one or more wheels.

5. The electric vehicle control system of claim 3, wherein the vehicle controller, based on the vehicle dynamic state, determines that torque vectoring, braking application, or both should be implemented.

6. The electric vehicle control system of claim 1, wherein the torque distribution instructions received by the power controller include instructions to increase torque or decrease torque for each of the one or more electric motors.

7. The electric vehicle control system of claim 1, further comprising:
a battery controller operably coupled to the vehicle controller and a battery;
wherein the vehicle controller determines a charge reception capability of the battery based on a predictive algorithm; and
wherein the vehicle controller determines the braking application based on the charge reception capability of the battery.

8. The electric vehicle control system of claim 1, wherein the vehicle controller, the power controller, and the braking controller are each included in a module configured to be attached to a platform for an electric vehicle.

9. The electric vehicle control system of claim 1, wherein the vehicle controller, the power controller, and the braking controller are communicatively coupled wirelessly.

10. A method for controlling torque vectoring and braking application of an electric vehicle, the method comprising:
collecting, by a vehicle controller, one or more vehicle conditions associated with a dynamic state of the vehicle;
determining, by the vehicle controller, the dynamic state of the vehicle based on the one or more vehicle conditions;
determining, by the vehicle controller, that one or more of torque vectoring, braking application, or both are needed based on the determined dynamic state of the vehicle;
determining, by the vehicle controller, an optimal torque vectoring and an optimal braking application based on the determined dynamic state of the vehicle; and
sending, by the vehicle controller, one or more of torque distribution instructions based on the determined optimal torque vectoring to a power controller, braking application instructions based on the determined optimal braking application to a braking controller, or both;
wherein the power controller is configured to control torque generation of one or more electric motors based on the torque distribution instructions received from the vehicle controller and wherein the braking controller is configured to control a braking system of the vehicle based on the braking application instructions received from the vehicle controller.

11. The method of claim 10, wherein the vehicle conditions include one or more of vehicle speed, vehicle acceleration, vehicle yaw rate, vehicle steering angle, and wheel slip.

12. The method of claim 10, wherein the vehicle dynamic state may be one or more of oversteering, understeering, traveling uphill, travelling downhill, and a loss of traction in one or more wheels.

13. The method of claim 10, wherein the torque distribution instructions include instructions to increase torque or decrease torque for each of one or more electric motors.

14. An electric vehicle control system comprising:
a vehicle controller configured to collect and process one or more vehicle conditions from one or more sensors, determine torque distribution and braking application based on the vehicle conditions, and generate torque distribution instructions and braking application instructions;
a power controller configured to control torque generation of one or more electric motors based on the torque distribution instructions received from the vehicle controller; and
a braking controller configured to control a braking system of the vehicle based on the braking application instructions received from the vehicle controller;
wherein the braking application instructions instruct the braking system to apply a braking force to one or more wheels in response to the vehicle conditions, wherein the torque distribution instructions instruct the one or more motors to increase or decrease torque in response to the vehicle conditions, and wherein the vehicle controller, the power controller, and the braking controller are each included in a module configured to be attached to a platform for an electric vehicle.

15. The electric vehicle control system of claim 14, wherein the one or more vehicle conditions include one or more of vehicle speed, vehicle acceleration, vehicle yaw rate, vehicle steering angle, and wheel slip; and
wherein each vehicle condition is received from one or more sensors or determined from signals received from one or more sensors.

16. The electric vehicle control system of claim 15, wherein the vehicle controller determines a vehicle dynamic state based on the one or more vehicle conditions.

17. The electric vehicle control system of claim 16, wherein the vehicle dynamic state may be one or more of oversteering, understeering, traveling uphill, travelling downhill, and a loss of traction in one or more wheels.

18. The electric vehicle control system of claim 16, wherein the vehicle controller, based on the vehicle dynamic state, determines that torque vectoring, braking application, or both should be implemented.

19. The electric vehicle control system of claim 15, wherein the torque distribution instructions received by the power controller include instructions to increase torque or decrease torque for each of the one or more electric motors.

20. The electric vehicle control system of claim 15, further comprising:
a battery controller operably coupled to the vehicle controller and a battery;
wherein the vehicle controller determines a charge reception capability of the battery based on a predictive algorithm; and
wherein the vehicle controller determines the braking application based on the charge reception capability of the battery.
